(19) United States
(12) Patent Application Publication
(10) Pub. No.: US 2015/0178869 A1
(43) Pub. Date: Jun. 25, 2015

(54) METHOD AND SYSTEM FOR ASSIGNING AND AGGREGATING LEGAL CLAIMS

(71) Applicant: Ben Kinney, Minneapolis, MN (US)

(72) Inventor: Ben Kinney, Minneapolis, MN (US)

(21) Appl. No.: 14/636,982

(22) Filed: Mar. 3, 2015

Related U.S. Application Data
(63) Continuation of application No. 13/973,643, filed on Aug. 22, 2013.

(51) Int. Cl. G06Q 50/18; G06Q 10/10

(52) U.S. Cl. CPC G06Q 50/18; G06Q 10/10

(57) ABSTRACT

The present invention provides a method and system for assigning and aggregating legal claims that would, individually, not be practicably actionable by claim holders. Legal claims are assigned and aggregated by providing claim holders with interfaces that allow the input of claim information and the assignment of claim rights. Assigned legal claims are grouped by prospective defendant, thereby allowing effective prosecution of the aggregated legal claims by one or a few parties.

### FIELD OF THE INVENTION

The invention relates to new methods and systems for legal claim assignment, and, more specifically, legal claim assignment for the purposes of aggregation of claim value.

### BACKGROUND

Class action lawsuits that allow plaintiffs to combine related, individual legal claims into a single case against one or more defendants have existed in one form or another for decades. Such lawsuits allow plaintiffs to litigate cases as a single unit, thereby dramatically increasing the resources that can be marshaled by the plaintiffs to pursue defendants. Those resources would not be available to plaintiffs for cases in which the monetary harm suffered by each plaintiff was not substantial.

Class action lawsuits can result from various causes of action including product liability, negligence, antitrust, and breach of contract. Unlike product liability, negligence, and antitrust class actions however, breach of contract class actions rely on the breach of an agreement to which the plaintiffs were a willing party prior to being damaged.

Recently, businesses have used the contractual relationship to all but eliminate customer class action lawsuits by including in their contracts standard “class action waiver” clauses, which prevent a damaged party from bringing a legal claim against the business as a class action. Instead, the class action waivers typically obligate the customers to bring any legal action in a small claims court or in a private arbitration.

Consequently, the result of such waivers is to virtually eliminate breach of contract liability for businesses that breach their contract in a manner that results in minor damages to each of their customers. For example, a breach of contract that leads to individual customers being overcharged a few dollars by a business that has millions of customers, wherein the standard contract between the business and its customers includes a class action waiver, would have the effect of increasing the revenues of the business substantially while all but eliminating the risk of a substantial lawsuit, because a class action lawsuit would be barred and individual customers would be unlikely to pursue legal action to recover a few dollars.

Notwithstanding the apparent inequity presented by class action waivers, the Supreme Court of the United States has recently upheld the validity of such waivers, and there is a clear trend in the business community to include class action waivers in all consumer contracts.

A method and system for aggregating individual legal claims, which would not individually be economically worthwhile to pursue, and assigning those claims to one or a few parties that could then successfully pursue the aggregate legal claims is needed in the art.

### SUMMARY OF THE INVENTION

The present invention provides a method for assigning and aggregating legal claims and systems implementing the same that are performed on a computer system. The method includes providing to legal claim holders an interface into which they can enter information related to their legal claim. The interface, in one embodiment, is a web page that is provided to claim holders and on which are various forms, buttons, and/or other interactive web page elements that allow claim holders to input information related to legal claims. A second interface is provided that allows claim holders to assign their ownership of their legal claim to another party.

Individual assignments and claim information are then associated with each other and the data are stored in a retrievable manner. In one embodiment, the data are stored as individual records in a database. The information obtained can be grouped according to whichever prospective defendant has been named or selected by the claim holder, thereby resulting in the aggregation of a plurality of separate, individual legal claims and their assignment to a single or a few entities that can thereafter effectively pursue a legal cause of action.

### BRIEF DESCRIPTION OF THE DRAWINGS

FIG. 1 represents a schematic view of one embodiment of a system of the present invention that performs a method for assigning and aggregating legal claims.

FIG. 2 represents a schematic view of one embodiment of a method of the present invention for assigning and aggregating legal claims.

FIG. 3 represents a schematic view of one embodiment of a claimant interface of the present invention showing various input fields of a web page for inputting legal claim information.

FIG. 4 represents a schematic view of one embodiment of a claimant interface of the present invention showing one method for claim holders to execute an assignment.

FIG. 5 represents a schematic view of one embodiment of a system of the present invention that performs a method for assigning and aggregating legal claims that uses various distributed resources.

### DETAILED DESCRIPTION

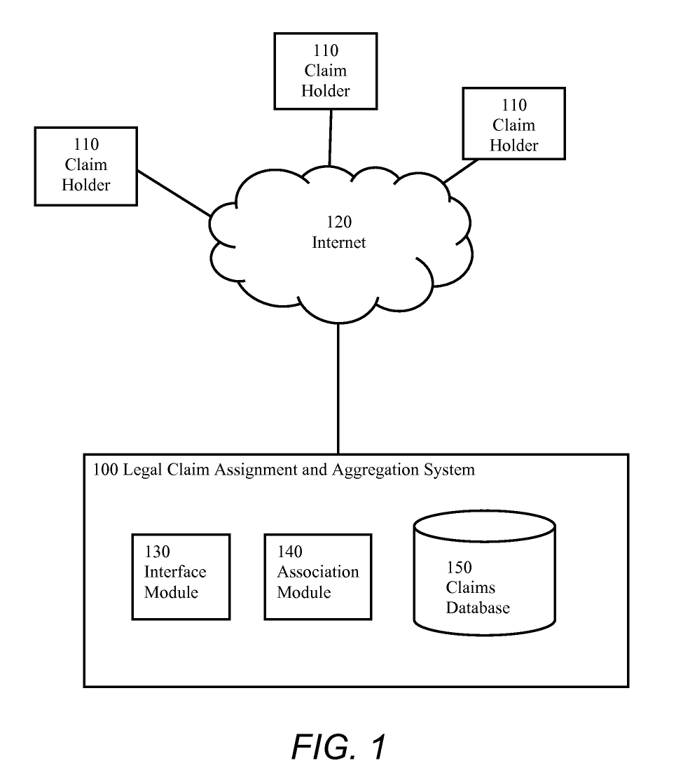

FIG. 1 illustrates a system architecture for a Legal Claim Assignment and Aggregation System 100 that allows claim holders 110 to assign their ownership interest in legal claims to one or more assignees through the use of the Internet 120.

Claim holders 110 will typically be individuals who possess a cognizable legal claim against one or more entities, which will typically be ongoing business concerns. The system and methods provided herein are useful for any type of legal claim, which include, but are not limited to, antitrust claims, tort claims, claims based on contracts, negligence claims, and product liability claims. In a particularly preferred embodiment claim holders 110 will have a breach of contract claim against a business entity that has breached a contract with a plurality of parties. In various embodiments, the methods and systems of the present invention are used to assign and aggregate any number of individual legal claims against a single entity. In some embodiments more than 1,000, 10,000, 100,000, 1,000,000, or 10,000,000 individual legal claims can be assigned and aggregated against a single entity.

Claim holders 110 can be communicatively coupled to the Internet 120 through any means, including, but not limited to, personal computers, including desktop and laptop designs, hand held tablets, smart phones, land line phones, client terminals, facsimile machines, and any other integrated device that allows communication through the Internet. Claim holders 110 and the Legal Claim Assignment and Aggregation System 100 can be connected to the Internet at any suitable node, including through commercial Internet Service Providers.

The Legal Claim Assignment and Aggregation System 100 is configured to implement the methods of the present invention. In the embodiment shown in FIG. 1, the Legal Claim Assignment and Aggregation System 100 comprises an Interface Module 130, an Association Module 140, and a Claims Database 150. In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules are implemented by software, they are stored on a computer readable storage device (for example, a hard disk drive), loaded into the memory, and executed by one or more processors included as part of the Legal Claim Assignment and Aggregation System 100. Alternatively, hardware or software modules may be stored elsewhere within the Legal Claim Assignment and Aggregation System 100.

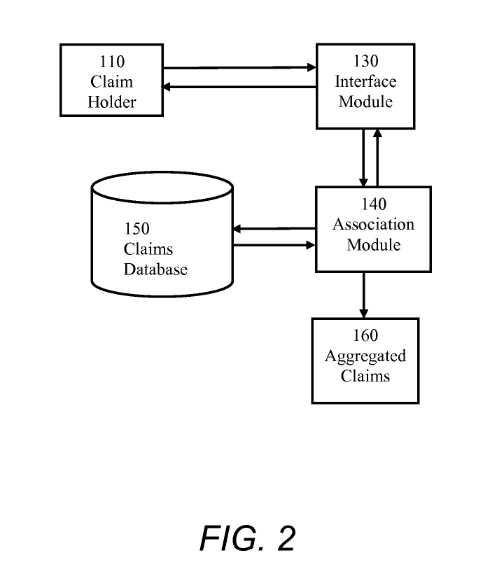

The Legal Claim Assignment and Aggregation System 100 includes hardware elements necessary for the operations described here, which can include one or more processors, high speed memory, hard disk storage and backup, network interfaces and protocols, input devices for data entry, and output devices for display, printing, or other presentations of data. The operations of the Legal Claim Assignment and Aggregation System 100 and its modules will be further described below with respect to FIG. 2. As will become apparent, the various data processing operations used to assign and aggregate legal claims are sufficiently complex and time consuming as to necessarily require the operation of a computer system such as the Legal Claim Assignment and Aggregation System 100 in order to practice the present invention.

One preferred method of the present invention comprises the steps of: providing to said claim holders a first claimant interface into which legal claim information related to said legal claims can be inputted, wherein said legal claim information includes a prospective defendant; providing to said claim holders a second claimant interface through which ownership of said legal claims can be assigned to one or more assignees with assignments; associating said legal claim information and said assignments with individual claim holders, thereby creating individual claim holder records; storing said individual claim holder records; and grouping said individual claim holder records into groups, wherein said prospective defendant of each of said groups is the same.

While steps in the methods of the present invention are described and claimed in a particular order for ease of presentation, it is understood that method steps can be performed in any suitable order that effectuates the assignment and aggregation contemplated herein.

One embodiment of a method of the present invention is shown schematically in

FIG. 2. As shown, each individual claim holder 110 interacts directly with the interface module 130. The interface module 130 provides a claimant interface to the claim holder 110. The claimant interface can be provided in any suitable form that allows the claim holder 110 to submit legal claim information to the Legal Claim Assignment and Aggregation System 100. Examples include, but are not limited to, voice prompting and recognition, numeric telephone entry, alpha numeric entry into graphical user interface forms, and form image transmission.

In preferred embodiments, claimant interfaces are provided in the form of one or more web pages served by the interface module 130, which comprises web server functionality. Web pages can be transferred to a claim holder 110 using any suitable data transfer and display protocols, including, but not limited to, the preferred method of using hypertext transport protocol (http). As shown in FIG. 2, various embodiments of the present invention comprise dynamic exchange between a claim holder 110 and the interface module 130.

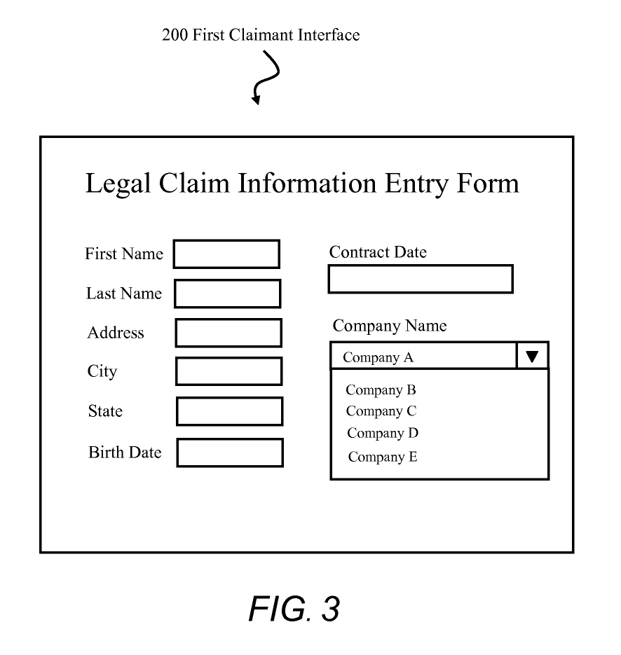

In one embodiment, the interface module 130 provides a claim holder 110 with a first claimant interface that contains elements that allow the claim holder 110 to enter and transmit legal claim information to the interface module 130. As described above, transmission of legal claim information can occur by any means that functions to transmit the legal claim information to the interface module 130. A preferred embodiment is shown in FIG. 3, which shows the preferred embodiment of a web page encoded in http that is transmitted from the interface module 130 to a claim holder 110 and presented to the claim holder 110.

As shown in FIG. 3 generally at 200, a first claimant interface can be a web page that provides a claim holder 110 with various fields into which the claim holder 110 can enter relevant legal claim information, which includes personal information and claim information. Fields for any desired input of any information that is relevant to the possible claims can be displayed, including, but not limited to, information specifying a claim holder's name, address, social security number, and age. Further, fields for entering claim information specific to a particular cause of action can be provided, including fields indicating the date on which particular events occurred, such as a contract date. In preferred embodiments, a list of prospective defendants is provided in the first claimant interface. FIG. 3 displays a prospective defendants list in the preferred embodiment as a drop down menu list element that allows a claim holder 110 to select a specified prospective defendant. As shown in FIG. 3, a prospective defendant list can provide a fixed number of defendants from which to choose, which are shown as Companies A through F in the schematic example provided.

As will be recognized by those of ordinary skill in the art, implementation of claimant interfaces can be accomplished using a myriad of web page elements, including JavaScript elements and other programmable elements that allow dynamic interaction between a claim holder and the interface module 130. Such dynamic interaction allows the interface module 130 to tailor claimant interfaces to the specific characteristics of the claim holder 110 as information is received by the interface module 130. In one embodiment, for example, a claim holder is first prompted, through the use of script elements, to choose a prospective defendant from a list, and, after choosing a prospective defendant and sending that information to the interface module 130, the interface module 130 sends further questions and/or fields for the claim holder 110 to complete that are specific to that particular prospective defendant or legal claim. For example, if a claim holder 110 chooses a prospective defendant that is presumptively liable for a defective product, the interface module 130 could return a web page that includes fields for identifying the serial number of the defective product. In a further example, the interface module 130 could prompt a claim holder 110, who chose a prospective defendant that was presumptively liable for breach of contract, the date on which the contract was formed and the amount of damages suffered as a result of the breach.

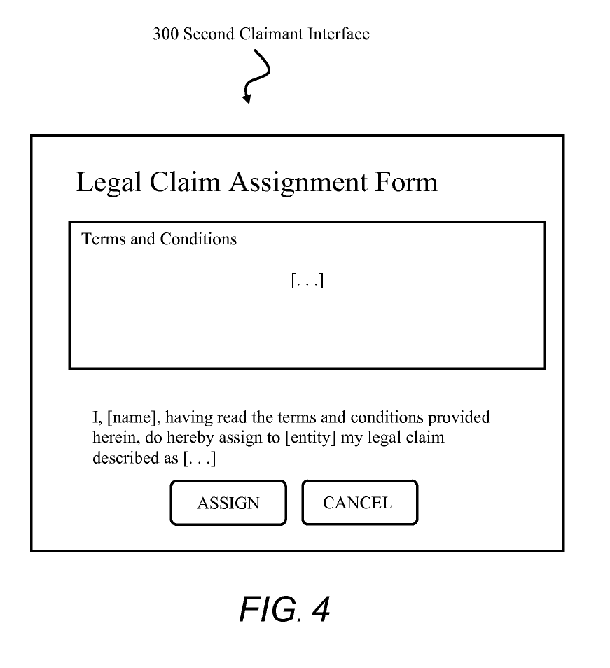

In one embodiment, the interface module 130 provides a claim holder 110 with a second claimant interface that contains elements that allow the claim holder 110 to assign the claim holder's ownership of the legal claim to another party. As described above, transmission of legal claim information can occur by any means that function to transmit the legal claim information to the interface module 130. A preferred embodiment is shown generally in FIG. 4 at 300, which shows the preferred embodiment of a web page encoded in http that is transmitted from the interface module 130 to a claim holder 110 and presented to the claim holder 110. As shown in FIG. 4, a claim holder 110 can take the legal steps required to assign the claim holder's rights in a legal claim to another party. The interface module 130 can be configured to dynamically prompt the claim holder 110 with the proper assignment information based on the jurisdiction of the claim holder 110 as determined by information received from the claim holder 110 through the first claimant interface. FIG. 4 shows a preferred assignment embodiment in which a claim holder 110 is presented with legal language describing the assignment and the legal result of assignation, as well as web page button elements allowing the claim holder 110 to either click “assign” or “cancel.” Upon clicking “assign,” a legal transfer of rights occurs, and the assignee receives ownership of the legal claim formerly held by the claim holder 110.

The interface module 130 shown in FIGS. 1 and 2 and described herein can be a single logical construct—for example a computer running a webserver—or it can comprise logical constructs in disparate locations. Further, the first claimant interface and the second claimant interface can be combined into a single interface, such as a single web page with all of the information shown in FIGS. 3 and 4, or can be parted into more than two claimant interfaces.

After interaction with the first claimant interface and the second claimant interface, a claim holder 110 will have transmitted legal claim information and an assignment to the interface module 130.

As shown in FIG. 2, in one embodiment of a method of the present invention, after the Legal Claim Assignment and Aggregation System 100 receives the legal claim information and the assignment, the association module 140 associates the legal claim information and the assignment with the individual claim holder 110 who has assigned his or her ownership of the claim in a single, individual claim holder record. In preferred embodiments, all of the information received from an individual claim holder 110 is associated in a single formatted record to allow other system modules and components to access the record information. In one embodiment, the Legal Claim Assignment and

Aggregation System 100 associates the information into a binary format that is suitable for storage in standard databases, and particularly in a format suitable for storage in a relational database.

As shown in FIG. 2, in one embodiment of a method of the present invention, after association of the information received from the claim holder 110, the Legal Claim

Assignment and Aggregation System stores the claim holder records in a claims database 150. The claims database can be any storage medium and format that accomplishes the goal of storing the claim holder records information until access to the information is desired. Database hardware can include hard drives, flash drives, thumb drives, ram, optical disks, and other data storage devices. In a preferred embodiment, the Legal Claim Assignment and Aggregation System stores claim holder records in a relational database located within a single computer or server. In other embodiments, claim holder records are stored in a distributed database implemented on multiple computers or servers.

As show in FIG. 2, in one embodiment of a method of the present invention the association module 140 groups claim holder records to form aggregated claims 160. The aggregated claims 160, in a preferred embodiment, are grouped into groups having claims with the same prospective defendant. Grouping and aggregation can be accomplished by any standard database query that matches individual claim holder record information with inputted search terms. Resulting groups can be visualized in any manner that is common in the art, including, but not limited to through projection from a monitor and printed on paper. Groups can be further filtered and regrouped by the association module 140 based on information found within each claim holder record.

The association module 140 can perform the steps of associating information, storing records, and grouping. Alternatively, separate modules on the same or different machines can implement the same steps independently and/or in a different order than that shown in FIG. 2.

In various further embodiments of the present invention, the systems and methods described herein are implemented without the use of the Internet by utilizing closed private networks, such as those that are found at large public institutions and private businesses. In these embodiments, private networks take the place of the Internet to communicatively couple claim holders 110 with the Legal Claim Assignment and Aggregation System 100.

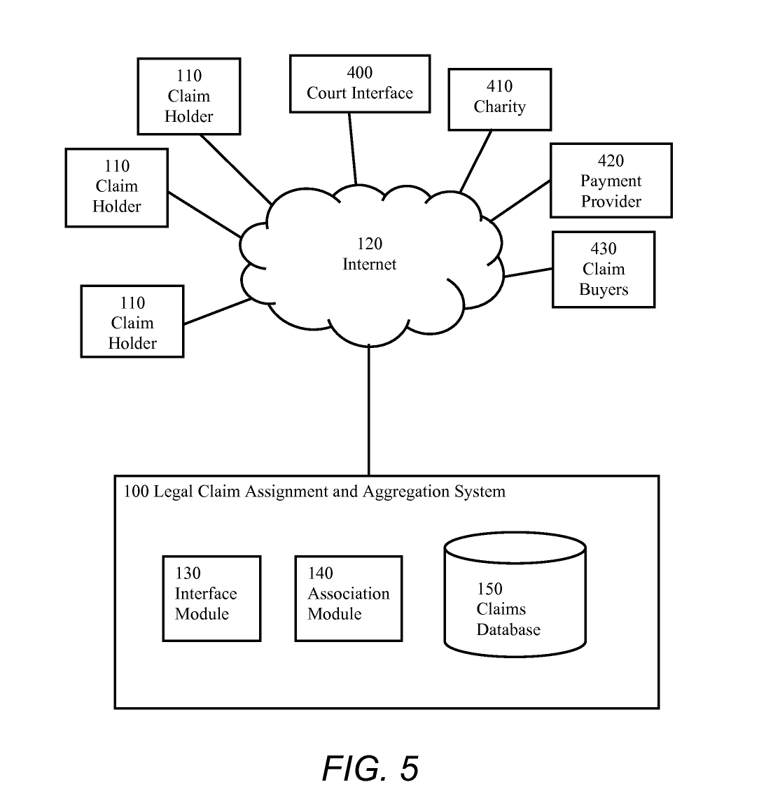

In further embodiments, as shown in FIG. 5, various resources connected to the Internet 120 are utilized by the Legal Claim Assignment and Aggregation System 100 to complement the functionality described herein throughout.

In one embodiment, a court interface 400 is accessed to ascertain, for example and without limitation, the status of ongoing cases, the number of individual cases that have been filed against a prospective defendant against whom a class action is putatively being considered, whether any actions have been filed against a particular prospective defendant, and the like.

In another embodiment, the Legal Claim Assignment and Aggregation System 100 interacts with one or more charities 410 that are communicatively coupled to the Internet for the purposes of exchanging information and/or contributing funds to the charity as the result of winning awards or obtaining settlements from cases brought from assigned, aggregated claims. Such fund distribution would be desirable, for example, if the value of each claim assigned by a claim holder 110 was too small to merit payment of a portion of any award to the original claim holder 110. Distributions to charity would have the dual desirable effects of encouraging claim holders 110 to assign their claims without compensation and benefiting a charity.

In yet other embodiments, claim holders 110 have claims that have more than a nominal value. In these embodiments a payment provider 420 communicatively coupled to the Internet can be used to both purchase claims from claim holders 110 at the time of assignment, or to pay claim holders 110 a portion of any awards received after assignation, aggregation, and successful prosecution of legal claims.

In yet a further embodiment, as shown in FIG. 5, one or more claim buyers 420 that are communicatively coupled to the Internet can interact with the Legal Claim Assignment and Aggregation System 100 to purchase, bid on, or otherwise make offers to buy assigned, aggregated claims. The Legal Claim Assignment and Aggregation System 100 can provide prospective buyers with live information as to the accumulated value of a legal claim against a particular entity.

By virtue of the present invention, it is now possible to provide a Legal Claim Assignment and Aggregation System 100 that assigns and aggregates legal claims that are nearly valueless individually into groups that can be effectively prosecuted.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

As would be known to one of skill in the art, it is not necessary for the elements to be configured as shown; the elements can be hosted by other entities or in some cases may even stand-alone. In some implementations of the system, the various elements may also appear in different configurations. Furthermore, it is not necessary for every embodiment of the invention to include all of the elements depicted. Likewise, as other elements and sub-elements are described throughout the invention, it should be understood that various embodiments of the invention may exclude elements and sub-elements described, that the elements and sub-elements may be hosted in configurations other than those shown, and that elements and sub-elements, even within an element, may be hosted in different locations or by different entities than those shown.

Some portions of this description describe the embodiments of the invention in terms of algorithms and symbolic representations of operations on data. These algorithmic descriptions and representations are commonly used by those skilled in the art to convey the substance of their work effectively to others skilled in the art. These operations, while described functionally, computationally, or logically, may be understood to be implemented by computer programs or equivalent electrical circuits, microcode, or the like. The particular division of functionality between the various modules or components may differ from that described herein, given the variety of software development environments and hardware platforms that may be used to practice the invention. The particular naming of the components, capitalization of terms, the attributes, data structures, or any other programming or structural aspect is not mandatory or significant, and the mechanisms that implement the invention or its features may have different names, formats, or protocols.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Such a computer program may be stored in a tangible computer readable storage medium or any type of media suitable for storing electronic instructions. Embodiments of the invention may also relate to an apparatus for performing the operations described herein. This apparatus may be specially constructed for the required purposes, and/or it may comprise a general-purpose computing device selectively activated or reconfigured by a computer program stored in the computer.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

What is claimed is:

1. A method, performed by a computer system, for assigning and aggregating legal claims owned by a plurality of claim holders, comprising:
providing to said claim holders a first claimant interface into which legal claim information related to said legal claims can be inputted, wherein said legal claim information includes a prospective defendant;
providing to said claim holders a second claimant interface through which ownership of said legal claims can be assigned to one or more assignees with assignments;
associating said legal claim information and said assignments with individual claim holders, thereby creating individual claim holder records;
storing said individual claim holder records; and,
grouping said individual claim holder records into groups, wherein said prospective defendant of each of said groups is the same.

2. The method of claim 1, wherein said first claimant interface and said second claimant interface are provided as one or more web pages on a web server.

3. The method of claim 1, wherein said first claimant interface receives an identification of a cause of action.

4. The method of claim 1, wherein said individual claim holder records number greater than 1,000 records.

5. The method of claim 1, wherein said providing said first claimant interface and said second claimant interface comprises serving one or more web pages to said claim holders.

6. The method of claim 1, wherein said providing said first claimant interface includes providing a list of prospective defendants.

7. The method of claim 1, wherein said providing said second claimant interface includes providing sufficient information to allow an assignment to be made by an individual claim holder by checking a checkbox, by signing electronically, or by clicking a button.

8. The method of claim 1, wherein said assignments are to a single assignee.

9. A computer program product, stored on a non-transitory computer storage medium, for assigning and aggregating legal claims owned by a plurality of claim holders, comprising:
providing to said claim holders a first claimant interface into which legal claim information related to said legal claims can be inputted, wherein said legal claim information includes a prospective defendant;
providing to said claim holders a second claimant interface through which ownership of said legal claims can be assigned to one or more assignees with assignments;
associating said legal claim information and said assignments with individual claim holders, thereby creating individual claim holder records;
storing said individual claim holder records; and,
grouping said individual claim holder records into groups, wherein said prospective defendant of each of said groups is the same.

10. The product of claim 9, wherein said first claimant interface and said second claimant interface are provided as one or more web pages on a web server.

11. The product of claim 9, wherein said first claimant interface receives an identification of a cause of action.

12. The product of claim 9, wherein said individual claim holder records number greater than 1,000 records.

13. The product of claim 9, wherein said providing said first claimant interface and said second claimant interface comprises serving one or more web pages to said claim holders.

14. The product of claim 9, wherein said providing said first claimant interface includes providing a list of prospective defendants.

15. The product of claim 9, wherein said providing said second claimant interface includes providing sufficient information to allow an assignment to be made by an individual claim holder by checking a checkbox, by signing electronically, or by clicking a button.

16. The product of claim 9, wherein said assignments are to a single assignee.

17. A computer system configured to assign and aggregate legal claims owned by a plurality of claim holders, comprising:
an interface module configured to provide to said claim holders a first claimant interface into which legal claim information related to said legal claims can be inputted, wherein said legal claim information includes a prospective defendant;
an interface module configured to provide to said claim holders a second claimant interface through which ownership of said legal claims can be assigned to one or more assignees with assignments;
an association module configured to associate said legal claim information and said assignments with individual claim holders, thereby creating individual claim holder records;
a claims database configured to store said individual claim holder records; and,
an association module configured to group said individual claim holder records into groups, wherein said prospective defendant of each of said groups is the same.

18. The computer system of claim 17, wherein said association module configured to associate and said association module configured to group are the same association module.

19. The computer system of claim 17, wherein the computer system is implemented in a single computer.

20. The computer system of claim 17, wherein the computer system is implemented in multiple computers.
